(19) United States
(12) Patent Application Publication
(10) Pub. No.: US 2011/0011200 A1
(43) Pub. Date: Jan. 20, 2011

(54) Bearing for a Connecting Rod

(75) Inventors: Jon F. V. Pohlman, Greenville, SC (US); Anthony P. Copper, Greenville, SC (US)

Correspondence Address: Nelson Mullins Riley & Scarborough LLP;IP Department, 100 North Tryon Street, 42nd Floor, Charlotte, NC, 28202-4000, US

(73) Assignee: KOYO BEARINGS USA LLC, Westlake, OH (US)

(21) Appl. No.: 12/794,385

(22) Filed: Jun. 4, 2010

Related U.S. Application Data
(60) Provisional application No. 61/226,009, filed on Jul. 16, 2009.

(51) Int. Cl. F16C 9/04; F16C 33/46; F16C 19/54; F16C 33/66; F16C 7/00

(52) U.S. Cl. 74/579 R; 384/572; 384/452; 384/454; 384/462

(57) ABSTRACT

A bearing for a connecting rod includes a retainer having a plurality of pockets spaced about a circumference of the retainer, a first end that defines a first flange, and a second end that defines a second flange opposite the first flange. The bearing also includes a plurality of radial bearing elements that supports a radial load, and each of the plurality of radial bearing elements is positioned in one of the plurality of pockets. A first plurality of axial bearing elements is positioned on the first flange and receives at least a portion of an axial load, and a second plurality of axial bearing elements is positioned on the second flange and receives at least a portion of the axial load.

### CLAIM OF PRIORITY

This application claims priority to U.S. Provisional Application No. 61/226,009, filed Jul. 16, 2009, the entire disclosure of which is incorporated by reference herein.

### FIELD OF THE INVENTION

The present invention relates to bearings for connecting rods. More specifically, the invention relates to a bearing capable of supporting radial and axial loads.

### BACKGROUND OF THE INVENTION

In reciprocating engines, a piston reciprocates within a cylinder. The piston is connected to a crankshaft by a connecting rod such that movement of the piston drives the crankshaft. A bearing is provided between the connecting rod and the crankshaft to absorb radial forces generated by the relative movement between the connecting rod and the crankshaft. The axial ends of the bearing contact a surface of the crankshaft. This contact (i.e., rubbing against each other) of the bearing and the crankshaft can cause the interface surface to wear poorly. Also, the friction generated between the connecting rod and the bearing and between the crankshaft and the bearing generates heat that can cause damage to the bearing or the components themselves. Misalignment of the components can result in the uneven distribution of forces and sometimes cause very large axial and radial forces to be exerted between the connecting rod and the crankshaft in a single location.

The prior art includes different attempts designed to decrease the amount of friction generated between the connecting rod and the crankshaft. One attempt includes lubricating the connecting rod. However, the lubricant eventually collects in an oil sump at the bottom of the engine block and must be replenished periodically. Some attempts have been made to increase the amount of lubricant that is retained in the bearing by forming lubrication scallops on the thrust surfaces of the bearing, increasing spray lubrication on rotating assemblies, and adding special coatings to the components. Although the methods described above aid in the reduction of friction and heat, these methods can fail to provide sufficient lubrication means for the bearing and undesirable amounts of friction and heat are still generated.

### SUMMARY OF THE INVENTION

In one construction, the invention provides a bearing for a connecting rod. The bearing includes a retainer that defines a retainer axis. The retainer includes a plurality of pockets spaced about a circumference of the retainer, a first axial flange on a first end of the retainer, and a second axial flange on a second end of the retainer opposite the first end. The bearing also includes a plurality of radial rolling elements, each of the plurality of radial rolling elements retained in one of the plurality of pockets. The bearing further includes means for absorbing forces directed in an axial direction substantially parallel to the retainer axis. The means are positioned on the first axial flange and the second axial flange.

In another construction, the invention provides a bearing for a connecting rod. The bearing includes a retainer having a plurality of pockets spaced about a circumference of the retainer, a first end that defines a first flange, and a second end that defines a second flange opposite the first flange. The bearing also includes a plurality of radial bearing elements that support a radial load, and each of the plurality of radial bearing elements is positioned in one of the plurality of pockets. A first plurality of axial bearing elements is positioned on the first flange and receives at least a portion of an axial load, and a second plurality of axial bearing elements is positioned on the second flange and receives at least a portion of the axial load.

In yet another construction, the invention provides a connecting rod assembly that includes a connecting rod and a bearing. The connecting rod includes a first end and a second end. The first end is configured to be coupled to a piston, and the second end is configured to be coupled to a crankshaft. The connecting rod assembly also includes a bearing coupled with the second end. The bearing includes a retainer having a plurality of pockets spaced about a circumference of the retainer, a first retainer end that defines a first flange, and a second retainer end that defines a second flange opposite the first flange. The bearing also includes a plurality of radial bearing elements that receives a radial load. Each of the plurality of radial bearing elements is positioned in one of the plurality of pockets. A first plurality of axial bearing elements is positioned on the first flange and receives at least a portion of an axial load, and a second plurality of axial bearing elements is positioned on the second flange and receives at least a portion of the axial load.

Other aspects of the invention will become apparent by consideration of the detailed description and accompanying drawings.

### BRIEF DESCRIPTION OF THE DRAWINGS

FIG. 1 is a perspective view of a connecting rod coupled to a bearing in accordance with the present invention.

FIG. 2 is a partial section view of the connecting rod and the bearing of FIG. 1

FIG. 3 is a partial planar view of the connecting rod and the bearing of FIG. 1.

FIG. 4 is a perspective view of the bearing of FIG. 1.

FIG. 5 is a perspective view of a second embodiment of a bearing in accordance with the present invention.

FIG. 6 is a perspective view of a third embodiment of a bearing in accordance with the present invention.

FIG. 7 is a perspective view of a fourth embodiment of a bearing in accordance with the present invention.

FIG. 8 is a section view of the connecting rod and bearing of FIG. 1 mounted on a crankshaft.

FIG. 9 is a section view of the connecting rod and bearing of FIG. 1 mounted on a crankshaft.

FIG. 10 is a partial perspective view of the connecting rod and bearing of FIG. 1 mounted on a crankshaft.

FIG. 11 is a partial perspective view similar to FIG. 10 of the connecting rod and bearing of FIG. 1 mounted on a crankshaft.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

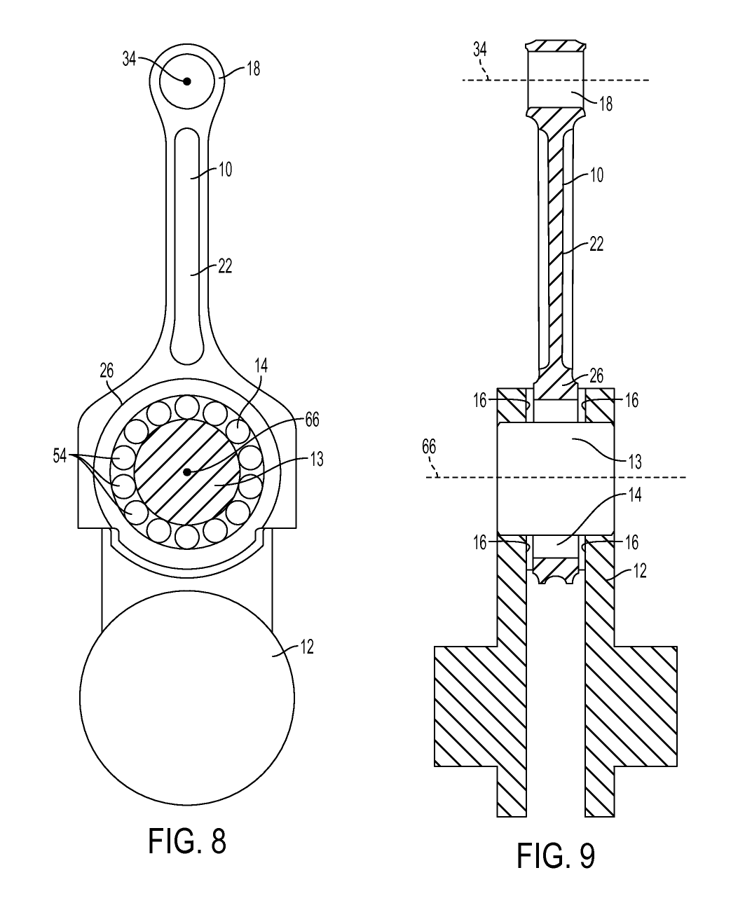

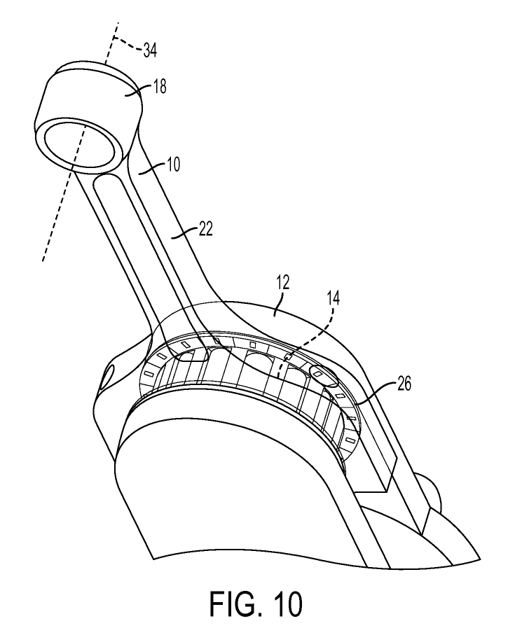

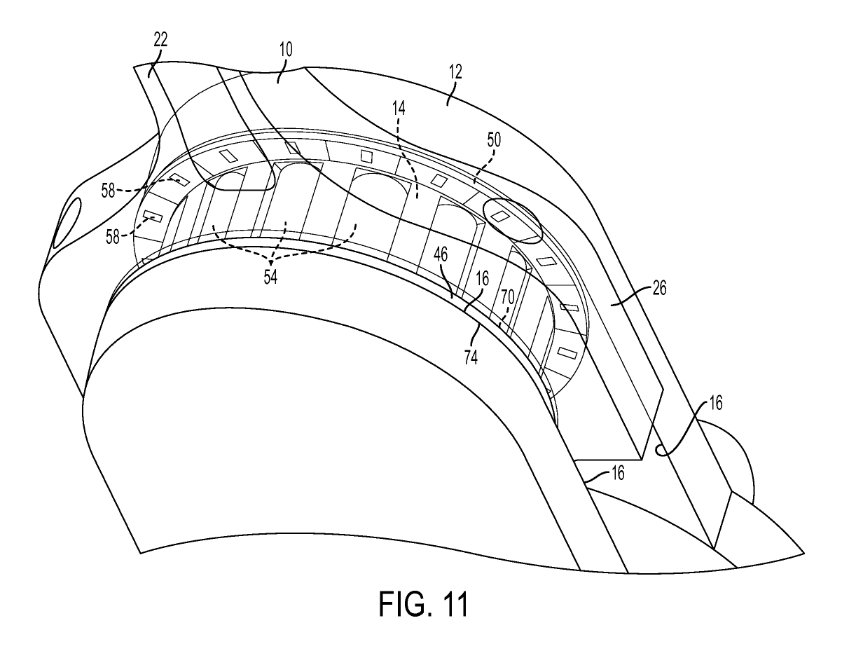

Referring generally to FIGS. 8-11, in reciprocating engines, a piston reciprocates within a cylinder and drives a crankshaft 12. The piston is connected to the crankshaft 12 by a connecting rod assembly including a connecting rod 10 and a bearing 14 such that the crankshaft 12 is driven by movement of the piston. The movement of the piston, the crankshaft 12, and the connecting rod 10 causes axial and radial forces to be exerted between the connecting rod 10 and the crankshaft 12, through the bearing 14. Gas pressure on the cylinder also contributes radial forces to the system. Furthermore, misalignment of the components can result in the uneven distribution of forces being exerted between the connecting rod 10 and the crankshaft 12.

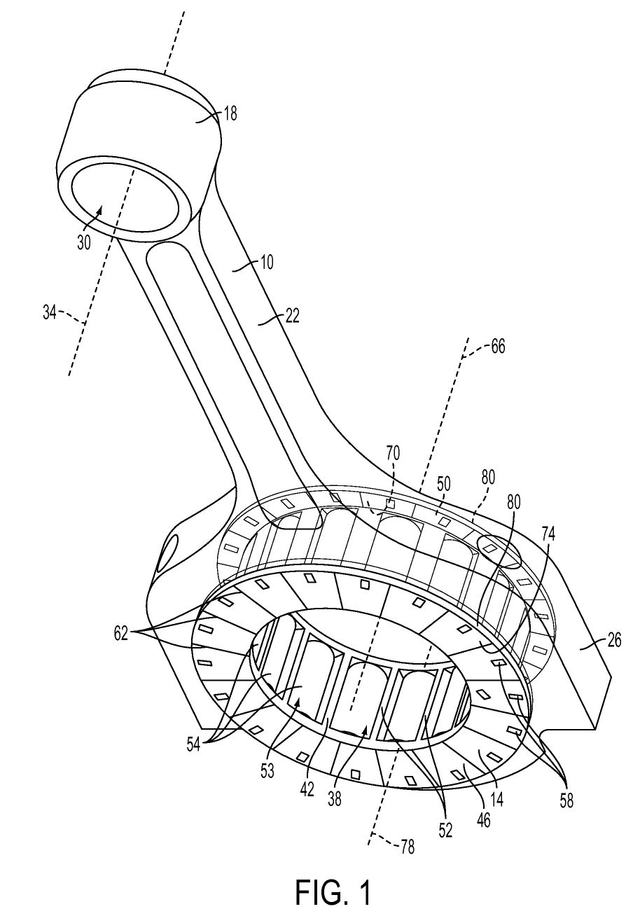

As illustrated in FIG. 1, the connecting rod 10 includes a first end 18, a rod portion 22, and a second end 26. The first end 18 is connected to the piston. More specifically, a piston pin is passed through an aperture 30 in the first end to couple the connecting rod 10 to the piston. A pivot axis 34 is defined through the center of the aperture 30 in the first end 18, and the connecting rod 10 pivots about the piston pin as the piston reciprocates in the cylinder. The second end 26 of the connecting rod 10 includes a second aperture 38. The crankshaft 12 passes through the second aperture 38 such that the crankshaft 12 is coupled to the connecting rod 10. The bearing 14 is positioned between the connecting rod 10 and the crankshaft 12 to absorb radial and axial forces generated therebetween.

The bearing 14 includes a retainer 42 having a first axial flange 46, a second axial flange 50, and bridge members 52. The first axial flange 46, second axial flange 50, and bridge members 52 are formed together as one piece. The bridge members 52 extend between the first axial flange 46 and the second axial flange 50 to define a plurality of pockets 53 arranged circumferentially about the retainer 42. Each pocket 53 is defined between two adjacent bridge members 52, the first axial flange 46, and the second axial flange 50. Each of a plurality of radial rolling elements 54 is retained within a corresponding one of the pockets 53. The retainer 42 has a snap-fit retention feature such that the radial rolling elements 54 are pressed into the pockets 53 and are retained therein. The snap-fit retention feature does not inhibit the rotational movement of the radial rolling elements 54.

In the illustrated embodiment, the retainer 42 is formed as one piece. Thus the illustrated bearing 14 is used with an assembled crankshaft 12. The assembled crankshaft 12 includes a plurality of pieces that are assembled together to form the crankshaft 12. The assembled crankshaft includes a plurality of crank pins 13 (one is shown in FIG. 9), and the bearing 14 is mounted on one of the crank pins 13.

In other constructions, the retainer 42 can have a split cage design and be formed as two separate pieces. Alternatively, the retainer 42 can be formed as one piece and later split or cut along a planar surface such that two substantially equal, semi-cylindrical halves are formed. The split cage retainer can be used with either an assembled crankshaft or a solid crankshaft 12. The two pieces of the retainer are positioned around the crankshaft 12, and the connecting rod is mounted thereto to retain the two pieces of the retainer around the crankshaft 12. In addition, the two separate pieces of the retainer can be joined together after being positioned around the crankshaft 12. For example, if the retainer is formed of a polymer, then each half of the retainer can be formed separately with one or more locking tabs. Thus, the retainer can have a snap fit interface that includes a locking tab on one or both halves of the retainer.

A retainer axis 66 is defined through the center of the retainer 42, which generally coincides with the center of the second aperture 38 of the connecting rod 10. The retainer axis 66 is substantially parallel to the pivot axis 34. As the piston pump reciprocates and the crankshaft 12 is driven by the connecting rod 10, radial and axial forces are generated. Radial forces are defined as forces directed in a direction substantially perpendicular to the retainer axis 66. Thus, radial forces are directed in a radial direction with respect to the bearing 14. Axial forces are defined as forces directed in a direction substantially parallel to the retainer axis 66. Thus, axial forces are directed in an axial direction with respect to the bearing 14. The plurality of radial bearing elements 54 are configured and positioned to provide radial support. The bearing 14 also includes a means for absorbing axial loads. The means includes axial bearing elements on the retainer 42 configured and positioned to provide axial support. The axial bearing elements can include rolling elements, a low-friction material coupled to the bearing, planar surfaces of the bearing, or other suitable means.

The means for absorbing axial loads of the bearing 14 of FIG. 1 includes a plurality of axial rolling elements 58 and a plurality of lubrication grooves 62. The radial rolling elements 54 absorb the radial forces generated by the reciprocating motion, and the axial rolling elements 58 absorb the axial forces generated by the reciprocating motion. In the illustrated construction, the radial and axial rolling elements 54 and 58 are cylindrical rollers. In other constructions, the axial and radial rolling elements 54 and 58 may be needles, balls, or other suitable load absorbing elements.

The first and second axial flanges 46 and 50 define inner thrust faces 70 and outer thrust faces 74. When the connecting rod 10 is mounted with the bearing 14, the outer surfaces of the connecting rod 10 are positioned adjacent the inner thrust faces 70 of the axial flanges 46 and 50. Similarly, when the connecting rod 10 and bearing 14 assembly are mounted on the crankshaft 12, the outer thrust faces 74 of the axial flanges 46 and 50 are positioned adjacent surfaces such as walls 16 (see FIGS. 9-11) defined by the crankshaft 12. During rotation of the crankshaft 12, the outer surfaces of the connecting rod 10 and the inner thrust faces 70 of the bearing 14 move with respect to each other, and the outer thrust faces 74 of the bearing 14 and the surfaces of the walls 16 defined by the crankshaft 12 move with respect to each other. In the absence of axial rolling elements 58, the surfaces rub together. Large frictional forces are created due to the movement, which generates an undesirable amount of heat. Furthermore, when surfaces rub against each other, the weaker of the two materials will wear away. Thus, to protect the crankshaft 12 and the connecting rod 10, the bearing 14 is typically made of a material that is weaker, or softer, than both the material of the crankshaft 12 and the material of the connecting rod 10. To decrease the amount of frictional force generated and to decrease the amount of heat generated, the bearing 14 includes the axial rolling elements 58 and the lubrication grooves 62.

The lubrication grooves 62 allow oil, grease, or other lubricants to flow between the lubrication grooves 62 and into contact with the bearing 14, the connecting rod 10, and the crankshaft 12. The lubrication decreases the frictional forces generated between the inner thrust faces 70 and the connection rod 10 and between the outer thrust faces 74 and the crankshaft 12 by reducing or preventing metal-to-metal contact. The lubrication grooves 62 also aid in retention of lubricant and thus decrease the amount of lubrication necessary and decrease the frequency with which lubrication is reapplied to the bearing 14.

The radial rolling elements 54 are evenly spaced around the circumference of the retainer 42 and are retained in the pockets 53. Each radial rolling element 54 is substantially cylindrical with a radial rolling element axis 78 (FIGS. 1 through 4, only one illustrated for clarity) that extends through the center of each radial rolling element 54 and along the length of the radial rolling element 54 in a direction that is substantially parallel to the retainer axis 66. The radial rolling elements 54 freely rotate about the radial rolling element axes 78 and roll along the surfaces of the connecting rod 10 and the crankshaft 12 to substantially decrease the amount of friction generated therebetween. Thus, radial forces exerted between the crankshaft 12 and the connecting rod 10 are absorbed by the radial rolling elements 54. In addition, because the radial rolling elements roll along the surfaces of the crankshaft 12 and the connecting rod 10, the surfaces of the bearing 14, the connecting rod 10, and the crankshaft 12 do not rub against each other, reducing the amount of friction and wear of the material. In addition, because the surfaces do not rub against each other, the connecting rod 10, the crankshaft 12, and the bearing 14 can be formed of similar materials with similar hardness if desired.

The bearing 14 also includes means for absorbing axial forces exerted on the connecting rod 10. The first and second axial flanges 46 and 50 extend radially outwardly from the retainer 42. The first axial flange 46 is positioned at a first end of the retainer 42, and the second axial flange 50 is positioned at an opposite second end of the retainer 42. The first and second axial flanges 46 and 50 are integrally formed as one piece with the retainer 42. The first and second axial flanges 46 and 50 include the plurality of axial rolling elements 58, which are positioned near an outboard edge 80 of the flanges 46 and 50. The axial rolling elements 58 allow the bearing 14 to dissipate axial loads, even while under radial loading. Each of the axial rolling elements 58 are positioned in one of a plurality of pockets 55 formed in the first and second axial flanges 46 and 50. The retainer 42 has a snap-fit retention feature such that the axial rolling elements 58 are pressed into the pockets 55 and are retained therein. The snap-fit retention feature does not inhibit the rotational movement of the axial rolling elements 58. The axial rolling elements 58 extend through the first and second axial flanges 46 and 50 and roll against the surfaces of the connecting rod 10 and the crankshaft 12 to reduce the amount of friction generated between the surfaces. Thus, the lubrication demand and the amount of heat generated are reduced.

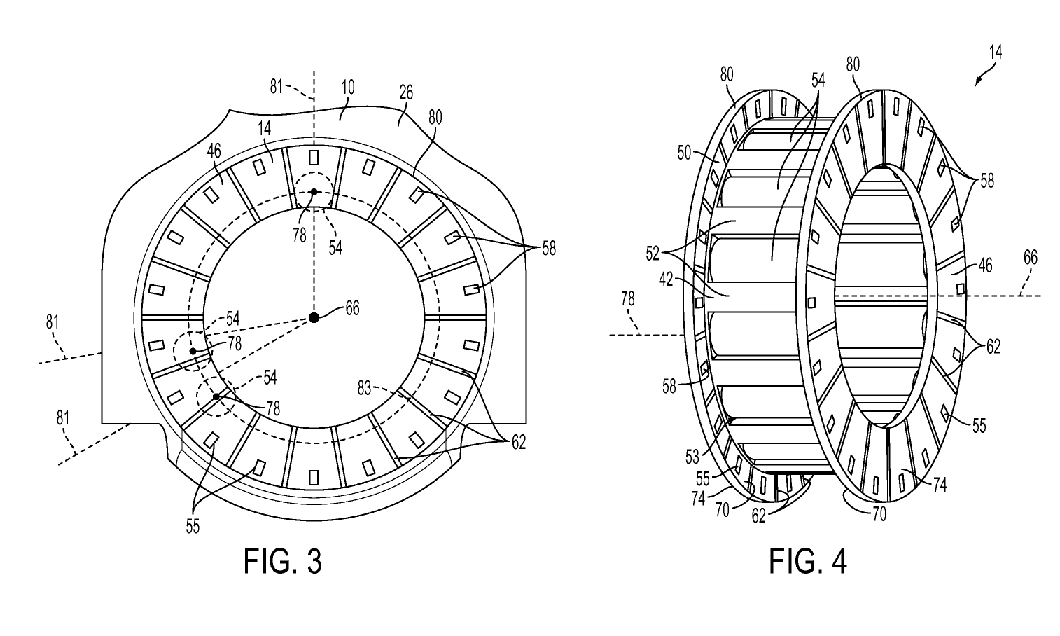

With reference to FIG. 3, the axial rolling elements 58 are positioned such that they do not all align with the radial rolling element axes 78 in either the circumferential or radial direction. The radial rolling element axes 78 define a pitch circle 83. The axial rolling elements 58 are illustrated as cylindrical rollers and are positioned radially outwardly from the pitch circle 83. As illustrated in FIG. 4, the axial rolling elements 58 are arranged circumferentially about the first axial flange 46 and the second axial flange 50. With reference to FIG. 3, each of the plurality of axial rolling elements 58 defines an axial rolling element axis 81 (only some of which are illustrated for clarity) along a length of each of the axial rolling elements 58. The axial rolling element axes 81 are substantially perpendicular to the retainer axis 66, which is illustrated as a point in FIG. 3. At least some of the axial rolling elements 58 are not aligned with the radial rolling elements 54. Thus, at least some of the axial rolling element axes 81 and the radial rolling element axes 78 do not intersect. In other constructions, the axial rolling elements 58 may be aligned with the radial rolling elements 54 such that the axial rolling element axes 81 intersect with corresponding radial rolling element axes 78. Alternatively, the axial rolling elements 58 may be positioned such that none of the axial rolling element axes 81 intersect the radial rolling element axes 78. In yet other constructions, the axial rolling elements 58 may be positioned in-line with the radial rolling elements 54 such that the radial rolling element axes 78 pass through the axial rolling elements 58.

In the illustrated embodiment, thirty-six axial rolling elements 58 are evenly distributed around the circumference of the bearing 14, with eighteen axial rolling elements 58 evenly distributed around the circumference of each of the first and second axial flanges 46 and 50. The number of axial rolling elements 58 on the first axial flange 46 is equal to the number of axial rolling elements 58 on the second axial flange 50. Furthermore, each axial rolling element 58 on the first flange 46 is directly opposed by a corresponding axial rolling element 58 on the second axial flange 50 (best illustrated in FIG. 4). Thus, the bearing 14 is evenly supported by the axial rolling elements 58 when mounted between the crankshaft 12 and the connecting rod 10. In other constructions, the number of axial rolling elements 58 may be twice the number of radial rolling elements 54, equal to the number of radial rolling elements 54, or a different number. Of course, in other constructions, the axial rolling elements 58 may be needles or balls.

The presence of the radial rolling elements 54 and the axial rolling elements 58 allows the retainer 42 to be formed of a variety of different materials. As described above, the surfaces of the retainer 42 do not rub against the surfaces of the connecting rod 10 or the surfaces of the crankshaft 12. Thus, the retainer 42 may formed of a hard metal that might otherwise cause damage to the connecting rod 10 and the crankshaft 12. If desired, the retainer 42 may be formed of other materials, such as soft metals, plastics, engineering polymers, or a different suitable material. This allows the retainer 42 to be formed of materials chosen for specific properties such as high heat tolerance.

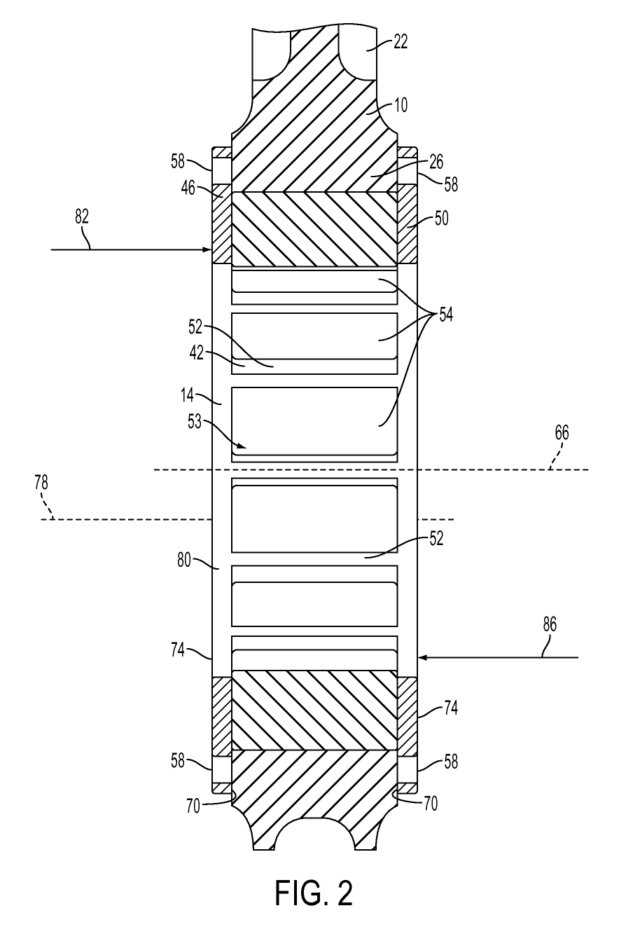

The axial rolling elements 58 aid in alignment between the connecting rod 10 and the crankshaft 12. For example, FIG. 2 illustrates thrust loads 82 and 86 that result from misalignment of the connecting rod 10 in the crankshaft 12. Misalignment may occur due to a twisting or bending of the connecting rod 10. Because the first and second axial flanges 46 and 50 are positioned adjacent the crankshaft walls 16, movement of the bearing 14 and connecting rod 10 is restricted and forces 82 and 86 are exerted by the crankshaft walls 16 on the bearing 14. The axial rolling elements 58 help absorb the forces 82 and 86 by allowing relative rotation of the bearing 14 about the retainer axis 66.

Although the previous construction was described with respect to a reciprocating engine that includes a piston, connecting rod 10, and a crankshaft 12, the bearing 14 may be used in other suitable applications for absorbing radial and axial loads simultaneously. For example, bearing 14 may alternatively be used as a bearing for a connection rod journal, a main bearing journal of a crankshaft 12, or on a cam shaft.

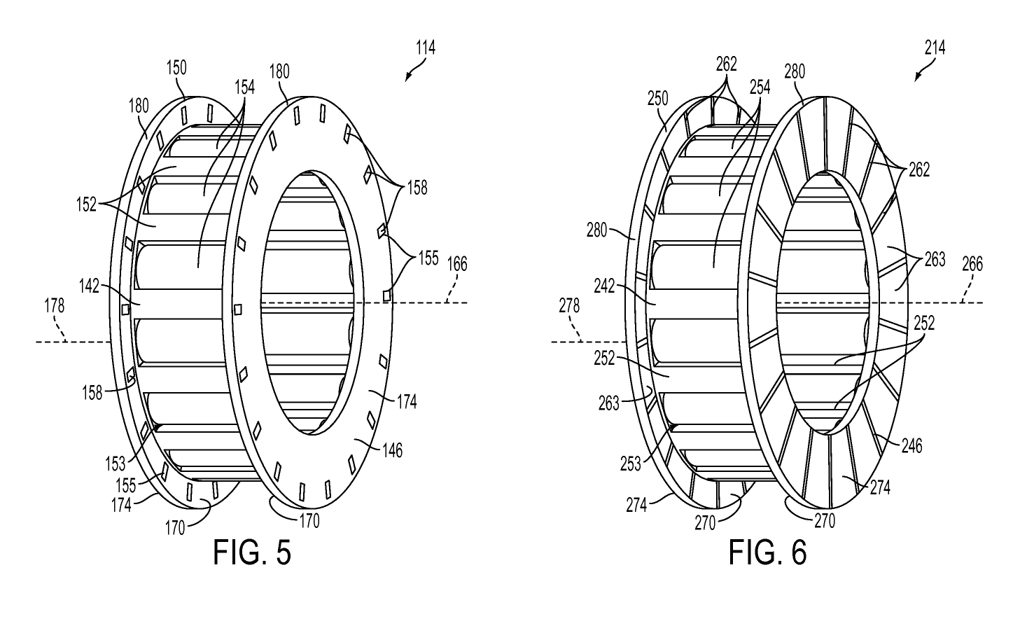

FIG. 5 illustrates a second embodiment of a bearing 114 in accordance with the present invention. The bearing 114 is similar to the bearing 14 of FIGS. 1-4 except it lacks lubrication grooves. Like components function similar to the components of the bearing 14 in FIGS. 1-4 and have been given like reference numerals of the 100 series. The axial rolling elements 158 carry the axial loads exerted on the bearing 114, and the radial rolling elements 154 carry the radial loads exerted on the bearing 114. In some constructions, the surfaces of the bearing 114 may be coated with a special chemical coating designed to hold lubricant. In other constructions, lubricant may be periodically sprayed on the bearing 114 to replenish the supply of lubricant thereto. Alternatively, lubricating grooves or other features may be formed in one or both of the connecting rod 10 and the crankshaft 12.

FIG. 6 illustrates a perspective view of a third embodiment of a bearing 214 in accordance with the present invention. The bearing 214 illustrated in FIG. 6 is similar to the bearing 14 of FIGS. 1-4 except the bearing 214 of FIG. 6 does not include axial rolling elements. Rather, means for absorbing forces directed in an axial direction include plane bearing surfaces (e.g., inner thrust surfaces 270 and outer thrust surfaces 274 between the lubrication grooves 262). Like components have been given like reference numerals of the 200 series. Because the inner and outer thrust surfaces 270 and 274 are in direct contact with the surfaces of the connecting rod 10 and the crankshaft 12, the thrust surfaces 270 and 274 may require high lubrication. If not properly lubricated, the friction generated as the surfaces move with respect to each other can generate excessive heat and decrease the operating performance of the engine.

Furthermore, the direct contact and rubbing together of the inner and outer thrust surfaces 270 and 274 with the surfaces of the connecting rod 10 and the surfaces of the crankshaft 12 during relative movement causes the softer material to be worn and removed over time. Thus, the retainer 242 is formed of a material that is softer than the material of the connecting rod 10 and softer than the material of the crankshaft 12. The retainer 242 acts as a sacrificial washer that dissipates thrust load and thus must be properly maintained during the lifetime of the engine. When the retainer 242 wears a specified amount, the bearing 214 is removed and replaced. The sacrificial surface reduces heat generation when composed of materials such as soft metals (e.g., bronze, tin, etc.).

In addition, the lifetime of the bearing 214 is extended with sufficient lubrication between the surfaces. As illustrated, lubricating grooves 262 extend in the radial direction away from the retainer axis 266. The lubricating grooves 262 are present on both the inner thrust surfaces 270 and the outer thrust surfaces 274 of the first and second axial flanges 246, 250. Adjacent lubricating grooves 262 define planar bearing surfaces 263 therebetween, and the plurality of planar bearing surfaces 263 define the inner and outer thrust surfaces 270, 274 of the first and second axial flanges 246, 250. The lubricating grooves 262 may be used alone or in combination with other methods for providing a sufficient supply of lubricant to the bearing 214. The lubricating grooves 262 allow the formation of a flat connecting rod 10 and crank because other lubricating features (e.g., scallops or channels formed on one or both of the connecting rod 10 and the crankshaft 12) are not required.

Similar to the bearing 14 of FIGS. 1-4, the bearing 214 absorbs both radial and axial forces generated during use. The radial rolling elements 254 carry the radial load, and the first and second axial flanges 246 and 250 simultaneously carry the axial load on the inner and outer thrust faces 270 and 274.

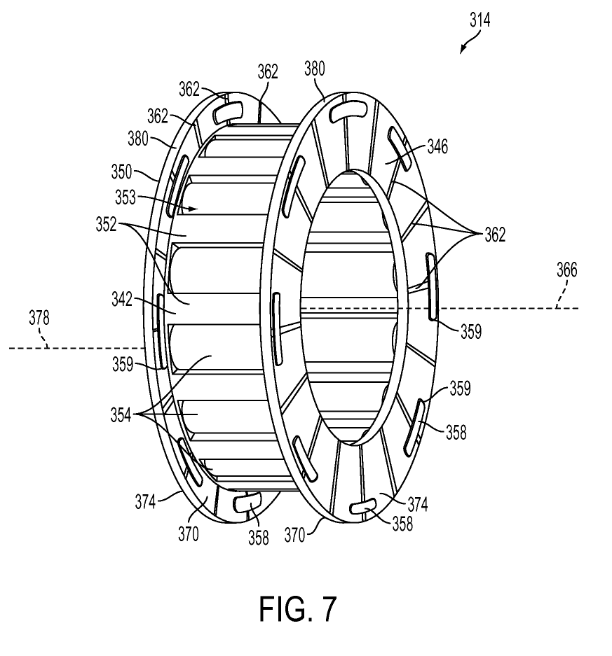

FIG. 7 is a perspective view of a fourth embodiment of a bearing 314 in accordance with the present invention. The bearing 314 illustrated in FIG. 7 is similar to the bearing 14 of FIGS. 1-4 except the bearing includes a different means for absorbing axial forces. More specifically, the means for absorbing axial forces includes a low-friction or friction-reducing material coupled with the first and second axial flanges 346,350. Like components have been given like reference numerals of the 300 series.

As illustrated, the low-friction material is in the form of material inserts 358. As used herein, the term insert defines a piece of material that is at least partially inserted into an aperture. Apertures 359 in the first and second axial flanges 346 and 350 are through apertures 359 that each contain one material insert 358. The material inserts 358 are thicker than the first and second axial flanges 346, 350 such that they extend through the apertures 359 and protrude from both the inner and outer thrust faces 370, 374. In other constructions, the apertures may be cavities or holes formed in one or both of the inner and outer thrust faces 370, 374 that do not extend through the first and second axial flanges 346, 350. The material inserts 358 may be retained in the cavities on one or both of the inner and outer thrust faces 370, 374 using an adhesive. In yet other constructions, the first and second axial flanges 346 and 350 may not contain apertures. Rather, low-friction material may be attached directly to the inner and outer thrust faces 370, 374 using an adhesive. If the retainer is formed of plastic, the material inserts 358 may be molded in the retainer 342. The low-friction material may take other forms. For example, a ring of low-friction material may be coupled to one or both of the inner and outer thrust faces 370, 374 of the first and second axial flanges 346,350. The ring of low-friction material may be a thin strip of material that does not substantially cover the thrust faces, or the ring of low-friction material may be shaped and sized to substantially cover the thrust faces.

The low-friction material (e.g., material inserts 358) can be metallic or plastic. Examples of suitable metallic materials include bronze, tin, and other soft metals, and an example of a suitable plastic or polymer is polytrimellitamide-imide, commonly known as PAI. The material can also be a lubricious material. Thus, the material wears better and has better friction reduction than the material used to form the retainer 342. This reduces the amount of friction and heat generated due to sliding contact between adjoining surfaces (e.g., between the material inserts 358 and the surfaces of the connecting rod 10, and between the material inserts 358 and the surfaces of the crankshaft 12). The material acts as a sacrificial wear surface because it is meant to wear out and be ground down slowly as the material slides against the surfaces of the connecting rod 10 and the crankshaft 12. The sacrificial surface erosion, or lubricity, lowers friction and interface temperatures.

In the illustrated embodiment, the material inserts 358 are arcuate pieces of material that generally follow the curvature of the first and second axial flanges 346 and 350. Each material insert 358 extends across at least one lubrication groove 362. A pitch circle is defined by the plurality of radial bearing element axes 378, similar to the pitch circle 83 of FIG. 3. The material inserts 358 are positioned outwardly from the pitch circle. Eight material inserts 358 are illustrated on the first axial flange 346. Although not all are shown, the second axial flange 350 also includes eight material inserts 358. Other embodiments can include more or less material inserts 358. The material inserts 358 can be positioned differently, such as inside or along the pitch circle, and can extend across zero or more lubrication slots 362. In addition, in other embodiments, the material inserts 358 can be different shapes, sizes, or thicknesses.

Thus, the invention provides, among other things, a bearing for a connecting rod that carries radial and axial forces simultaneously. Various features and advantages of the invention are set forth in the following claims.

What is claimed is:

1. A bearing for a connecting rod, the bearing comprising:
a retainer that defines a retainer axis, the retainer including;
a plurality of pockets spaced about a circumference of the retainer;
a first axial flange on a first end of the retainer; and
a second axial flange on a second end of the retainer opposite the first end;
a plurality of radial rolling elements, each of the plurality of radial rolling elements retained in one of the plurality of pockets; and
means for absorbing forces directed in an axial direction substantially parallel to the retainer axis, the means positioned on the first axial flange and the second axial flange.

2. The bearing of claim 1, wherein each of the plurality of radial rolling elements defines a radial rolling element axis that is substantially parallel to the retainer axis, the radial rolling element axes defining a pitch circle, and wherein the means for absorbing forces directed in an axial direction are positioned on the first axial flange and the second axial flange radially outwardly of the pitch circle.

3. The bearing of claim 1, wherein the first axial flange and the second axial flange include a second plurality of pockets spaced about the circumference of the retainer, and wherein the means for absorbing forces in an axial direction includes a plurality of axial rolling elements, each of the plurality of axial rolling elements positioned in one of the second plurality of pockets.

4. The bearing of claim 3, wherein the plurality of axial rolling elements is one of a plurality of cylindrical rollers, a plurality of balls, and a plurality of needle rollers.

5. The bearing of claim 3, further including a plurality of radially extending lubrication grooves positioned on the first axial flange and the second axial flange.

6. The bearing of claim 1, wherein the means for absorbing forces directed in an axial direction includes a low-friction material coupled with the first axial flange and the second axial flange.

7. The bearing of claim 6, wherein the low-friction material coupled with the first and second axial flanges is composed of a lubricious material.

8. The bearing of claim 6, wherein the low-friction material coupled with the first and second axial flanges includes a plurality of inserts positioned in apertures in the axial flanges.

9. The bearing of claim 6, further including a plurality of radially extending lubrication grooves positioned on the first axial flange and the second axial flange.

10. The bearing of claim 1, wherein the means for absorbing forces directed in an axial direction includes a plurality of planar surfaces defined between radially extending grooves.

11. The bearing of claim 10, wherein each of the first axial flange and the second axial flange defines an outer thrust surface and an inner thrust surface, and wherein each of the plurality of radially extending grooves extends radially outward along one of the outer thrust surfaces and the inner thrust surfaces.

12. A bearing for a connecting rod, the bearing comprising:
a retainer that includes;
a plurality of pockets spaced about a circumference of the retainer;
a first end that defines a first flange;
a second end that defines a second flange opposite the first flange;
a plurality of radial bearing elements that support a radial load, each of the plurality of radial bearing elements positioned in one of the plurality of pockets;
a first plurality of axial bearing elements positioned on the first flange that receives at least a portion of an axial load; and
a second plurality of axial bearing elements positioned on the second flange that receives at least a portion of the axial load.

13. The bearing of claim 12, wherein the first plurality of axial bearing elements and the second plurality of axial bearing elements include rolling elements.

14. The bearing of claim 12, wherein the first plurality of axial bearing elements and the second plurality of axial bearing elements include a low-friction material.

15. The bearing of claim 12, wherein the retainer defines a retainer axis, wherein each of the plurality of radial bearing elements defines a radial rolling element axis that is substantially parallel to the retainer axis, the radial rolling element axes defining a pitch circle, and wherein the first plurality of axial bearing elements and the second plurality of axial bearing elements are positioned radially outwardly of the pitch circle.

16. A connecting rod assembly comprising:
a connecting rod that includes a first end and a second end, the first end configured to be coupled to a piston and the second end configured to be coupled to a crankshaft; and
a bearing coupled with the second end, the bearing including
a retainer that includes a plurality of pockets spaced about a circumference of the retainer, a first retainer end that defines a first flange, and a second retainer end that defines a second flange opposite the first flange;
a plurality of radial bearing elements that receives a radial load, each of the plurality of radial bearing elements positioned in one of the plurality of pockets;
a first plurality of axial bearing elements positioned on the first flange that receives at least a portion of an axial load; and
a second plurality of axial bearing elements positioned on the second flange that receives at least a portion of the axial load.

17. The connecting rod assembly of claim 16, wherein the first plurality of axial bearing elements and the second plurality of axial bearing elements include rolling elements.

18. The connecting rod assembly of claim 16, wherein the first plurality of axial bearing elements and the second plurality of axial bearing elements include a low-friction material.
